(19) United States
(12) Patent Application Publication
(10) Pub. No.: US 2007/0005860 A1
(43) Pub. Date: Jan. 4, 2007

(54) Interrupt control system and method

(75) Inventors: Ying-Chih Lu, Taipei (TW); Wen-Chian Chao, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/394,978

(22) Filed: Mar. 30, 2006

(30) Foreign Application Priority Data
Jun. 29, 2005 (TW) 094121809

(51) Int. Cl. G06F 13/24

(52) U.S. Cl. 710/260

(57) ABSTRACT

An interrupt control system is applied in an electronic device having an interrupt service system, for controlling the interrupt service system to execute corresponding interrupt handlers. The interrupt control system includes a setting unit having a setting interface for setting a variety of specified interrupt control instructions; a storage unit having a first data storage area and a second data storage area, with an interrupt control program being stored in the first data storage area; and a central processing unit electrically connected to the setting unit and the storage unit, for storing the specified interrupt control instructions set by the setting unit to the second data storage area and executing the interrupt control program stored in the first data storage area, so as to control the interrupt service system to execute the corresponding interrupt handlers in accordance with the specified interrupt control instructions.

### BACKGROUND OF THE INVENTION

1. Field of the Invention

The present invention relates to an interrupt control system and method thereof and more particularly, to an interrupt control system and method for controlling and managing an interrupt service system in an electronic device.

2. Description of Related Arts

SMI is an interrupt that cannot be masked and has a first priority. In other words, i.e. a central processing unit (CPU) will immediately jump to a SMI Handler to execute the corresponding operation when an SMI signal is triggered. As to the current design of electronic devices, when communications between hardware components are abnormal, for example, Memory Single Bit Error, Memory Multi-Bit Error, Parity Error/System error of PCI/PCI-X/PCI-E/System Operation Cycle, fan error SMI, system overheat SMI, CPU Internal error SMI, CPU Machine Check SMI, SMI of NMI (Non Mask Interrupt), IO Check error SMI and the like, an SMI signal is usually triggered to inform CPU jump to a SMI Handler immediately to do the corresponding operation. While a basic input/output system (BIOS) is executing a power-on self test (POST) process, the SMI Handler will be read to a specified memory area automatically, generally, the specified area is at the address segment from A0000h to BFFFFh in the memory.

SMI Handler is programmed to BIOS flash ROM directly by BIOS developer at present, accordingly the data mode of current SMI Handler is fixed and operations can not be replaced, intercepted or added to the original SMI Handler according to the practical requirements of users.

Thus, the present subject to be solved is to develop an interrupt control system and method thereof, so that the SMI Handler can be controlled according to the practical requirements of users.

### SUMMARY OF THE INVENTION

According to the above mentioned defects of the prior art, it is the primary objective of the present invention to provide an interrupt control system and method thereof which can control an interrupt service system in an electronic device so as to make it more flexible in System Management Interrupt (SMI) operation according to the practical requirements of users.

It is another objective of the present invention to provide an interrupt control system and method thereof which can monitor and correct the SMI operation to raise its application value.

To attain these and other objects disclosed above, the present invention provides an interrupt control system and method thereof. The interrupt control system is applied in an electronic device having an interrupt service system for controlling the interrupt service system to execute corresponding interrupt handlers. The interrupt control system includes a setting unit having a setting interface for setting a variety of specified interrupt control instructions, a storage unit having a first data storage area and a second data storage area, an interrupt control program being stored in the first data storage area, and a central processing unit electrically connected to the setting unit and the storage unit for storing the specified interrupt control instructions set by the setting unit to the second data storage area and executing the interrupt control program stored in the first data storage unit, so as to control the interrupt service system to execute the corresponding interrupt handlers in accordance with the specified interrupt control instructions.

According to the preferred embodiment, the interrupt control system is an application program running in an operating system of the electronic device. The interrupt service system utilizes an SMI Handler, which is embedded in a basic input/output system (BIOS) of the electronic device, to execute the interrupt handlers. The interrupt control system further includes an editing unit for editing User Handlers. The specified interrupt control instructions include a disabling selection, an enabling selection, a periodically disabling selection, a periodically enabling selection of the SMI Handler, replacing the SMI Handler with the User Handler, adding the User Handler to the SMI Handler, and deleting the User Handler from the SMI Handler. The interrupt control instructions stored in the second data storage area are automatically cleared after the electronic device is powered-off. The CPU utilizes the interrupt control program to perform a write operation on an input/output port of the electronic device, so as to trigger an interrupt signal. The interrupt service system produces a response code for displaying a current performing state and transmit the response code to the interrupt control program when the interrupt control program is controlling the interrupt service system to execute the corresponding interrupt handler operation. The CPU starts to execute the interrupt control program as soon as the interrupt service system receives an interrupt signal or performs an operation in accordance with a rule defined by the interrupt control instructions.

The interrupt control method includes storing an interrupt control program in a first data storage area, displaying a setting interface for setting specified interrupt control instructions and storing the specified instructions in a second data storage area, and executing the interrupt control program stored in the first data storage area for controlling the interrupt service system to execute the corresponding interrupt handler operation in accordance with the specified interrupt control instruction. The interrupt control system is an application program running in an operating system of the electronic device. The interrupt service system utilizes a SMI Handler to execute the interrupt handlers and the SMI Handler is embedded in the BIOS of the electronic device. The interrupt control method further includes editing a User Handler and storing the User Handler in the second data storage area. The specified interrupt control instructions include a disabling selection, an enabling selection, a periodically disabling selection, a periodically enabling selection of the SMI Handler, replacing the SMI Handler with the User Handler, adding the User Handler to the SMI Handler, and deleting the User Handler from the SMI Handler. The CPU utilizes the interrupt control program to perform a write operation to an input/output port of the electronic device, so as to trigger an interrupt signal. The interrupt service system produces a response code for displaying a current performing state and transmits the response code to the interrupt control program when the interrupt control program is controlling the interrupt service system to execute the corresponding interrupt handler operation. The CPU starts to execute the interrupt control program as soon as the interrupt service system receives an interrupt signal or performs an operation in accordance with a rule defined by the interrupt control instruction.

The interrupt control system and method thereof of the present invention is to set up an interrupt control system applied for controlling the interrupt service system and managing the related control while the SMI Handler is doing an interrupt operation, so the SMI operation can satisfy the practical requirements of users.

### BRIEF DESCRIPTIONS OF THE DRAWINGS

FIG. 1 is a functional block diagram of an electronic device having an interrupt service system and an interrupt control system of the preferred embodiment according to the present invention; and

FIG. 2 is a flow chart of an interrupt control method according to the present invention.

### DETAILED DESCRIPTIONS OF PREFERRED EMBODIMENTS

The following special embodiment is provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

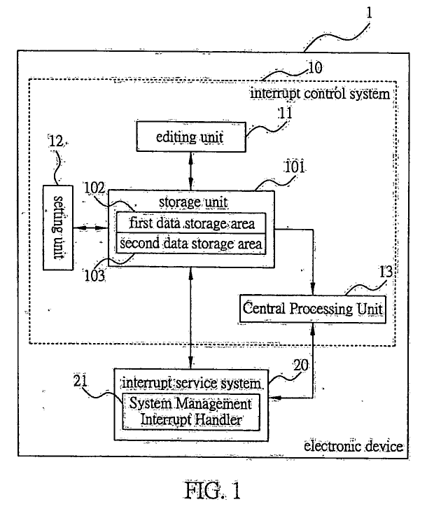

FIG. 1 is a functional block diagram of an electronic device 1 having an interrupt control system 10 and an interrupt service system 20 of the preferred embodiment according to the present invention. According to the preferred embodiment, the electronic device 1 is a personal computer (PC), a notebook, a personal digital assistant (PDA), a palm computer and the like. The interrupt control system 10 of the present invention is used for controlling the interrupt service system 20 to executing corresponding interrupt handler operations according to a specified interrupt control instruction. According to the preferred embodiment, the interrupt service system 20 executes the related interrupt handler operations with an SMI Handler 21 running in the BIOS program. The interrupt control system 10 is an application program running in an operating system of the electronic device 1. According to the preferred embodiment, the operating system is, for example, WINDOWS, DOS and the like. After the electronic device 1 is powered on and the BIOS has finished the POST process, the SMI Handler 21 is loaded to a specified memory address. Then the operating system is executed, thus the SMI Handler 21 is controlled by the interrupt control system 10.

The interrupt control system 10 comprises a storage unit 101, an editing unit 11, a setting unit 12 and a CPU 13. It should be noted the interrupt control system 10 further comprises other various functional unit. However only components related to the present invention are shown in this structure and other irrelevant components are not shown in FIG. 1 for the sake of simplification.

The storage unit 101 comprises a first data storage area 102 and a second data storage area 103. The first data storage area 102 is used for storing an interrupt control program and a program edited by the editing unit 11 (which will be described in detail in the following paragraphs). According to the preferred embodiment, the first storage area 102 is a memory. The second data storage area 103 is used to store data set by the setting unit 12 (which will be described in the following paragraphs), and the data will be cleared automatically after the electronic device 1 is powered-off. According to the preferred embodiment, the second data storage area 103 is a random access memory (RAM).

The editing unit 11 is used for providing an editing interface for users to edit corresponding User Handlers according to practical requirements.

The setting unit 12 is used for providing a setting interface. According to the preferred embodiment, the setting interface 12 is a selecting interface having a plurality of “interrupt control instruction” selections for users to select an interrupt control instruction according to the requirement. The “interrupt control instruction” selections comprise a variety of selections, such as a disabling selection, an enabling selection, a periodically disabling selection, a periodically enabling selection, a replacing selection (i.e. replacing the SMI Handler 21 with a User Handler), an adding selection (adding the User Handler to the SMI Handler 21), and a deleting selection (deleting the User Handler from the SMI Handler 21) for the SMI Handler 21. The disabling and enabling selections refer to stopping and activating functions of the SMI Handler 21 respectively. It should be noted that the User Handler according to the present invention can not be disabled. Furthermore, the periodically disabling and periodically enabling selections refer to stopping and activating the functions of the SMI Handler 21 respectively every a specified period, for example every 60 minutes. The replacing selection refers to disabling the SMI Handler 21 and executing the related interrupt operations by the User Handler. The adding selection refers to executing the User Handler prior to the SMI Handler 21 and the interrupt service system 20 copying all of the User Handlers which are added in the SMI Handler 21 by users to a system memory. To find enough storage space of the memory with respect to the User Handler, the memory in which the SMI Handler 21 is located (from A0000H to BFFFFH) should be searched first, then a T-segment (if the T-segment is supported by a chipset and the BIOS), and finally an empty memory area which is located from E0000H to EFFFFH or from C0000H to DFFFFH. The deleting selection refers to deleting the User Handler and executing the SMI Handler 21 only.

The CPU 13 is electrically connected to the setting unit 12 and the storage unit 101, and is used to store the specified interrupt control instructions set in the setting unit 12 to the second data storage area 103 (the specified interrupt control instructions stored in the second data storage area 103 will be automatically cleared after the electronic device 1 is powered-off). The CPU 13 monitors the operations of the interrupt service system 20. When the interrupt service system 20 receives an interrupt signal or executes an operation in accordance with a rule defined by the interrupt control instruction, the interrupt control program stored in the first data storage area 102 is executed to control the interrupt service system 20 to execute the corresponding interrupt handler operations in accordance with the specified interrupt control instructions stored in the second data storage area 103.

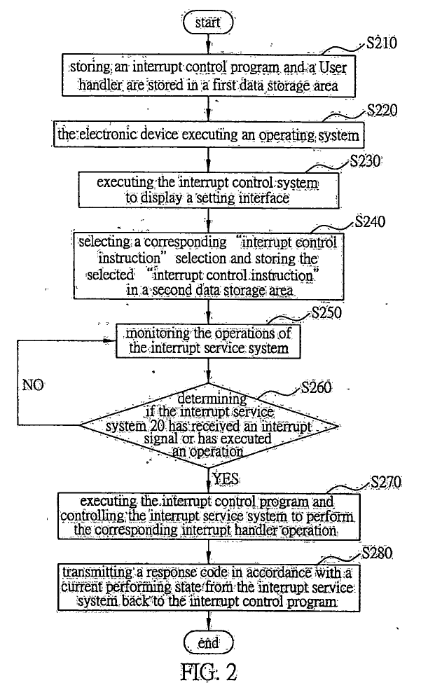

FIG. 2 is a flow chart of an interrupt control method according to the present invention. The interrupt control method is applied in the electronic device 1 having the interrupt service system 20. According to the embodiment, the electronic device 1 is a PC. The interrupt control method starts in step S210. In step S210, an interrupt control program and a User Handler complied based on the requirement of users in the first data storage area 102 of the electronic device 1. The interrupt control method then proceeds to step S220.

In step S220, after the electronic device 1 is powered on and the BIOS has finished the POST process, the SMI Handler 21 is loaded to a specified memory address, and the operating system is successively executed. Then proceed to step S230.

In step S230, the interrupt control system 10 is executed to display a setting interface having a plurality of “interrupt control instruction” selections for users. In this embodiment, the “interrupt control instruction” selections comprise a disabling selection, an enabling selection, a periodically disabling selection, a periodically enabling selection, a replacing selection (i.e. replacing the SMI Handler 21 with the User Handler), an adding selection (adding the User Handler 21 in the SMI Handler), and a deleting selection (deleting the User Handler from the SMI Handler) for SMI Handler 21. Then proceed to step S240.

In step S240, a corresponding “interrupt control instruction” selection is selected and the “interrupt control instruction” is stored in the second data storage area 103. In this embodiment, the second data storage area 103 is a RAM. Then proceed to step S250.

In step S250, the operations of the interrupt service system 20 of the electronic device 1 are monitored. Proceed to step S260.

In step S260, the interrupt service system 20 is determined if having received an interrupt signal or having executed an operation in accordance with the rule defined by the interrupt control instruction stored in the second data storage area 103. If the interrupt service system 20 is determined having received an interrupt signal or having executed an operation, the interrupt control method proceeds to step S270, or proceeds to step S250.

In step S270, the interrupt control program is executed and the interrupt service system 20 is controlled to perform the corresponding interrupt handler operation according to the interrupt control instruction stored in the second data storage area 103. Then proceed to step S280.

In step S280, the interrupt service system 20 translates the current operating state into a response code according to a predetermined standard and transmits the response code back to the interrupt control program for displaying the response code and informing the user. For example, a response code 00 represents an interrupt control instruction is performed successfully, a response code 01 represents the SMI Handler 21 is disabled, a response code 02 represents the SMI Handler 21 is enabled, a response code 03 represents there is not enough space for storing the User Handler, a response code 04 represents the User Handler has been existed in SMI Handler 21, a response code 05 represents the User Handler is not existed, a response code 06 represents the SMI Handler 21 is periodically enabled, a response code 07 represents the SMI Handler 21 is periodically disabled, and so on.

As a result, the interrupt control system and method thereof of the present invention is to set up an interrupt control application program in a computer for users to set a corresponding interrupt control instruction and control the interrupt service system of the computer to manage the related control according to the interrupt control instruction. So the SMI operation can make it more flexible in System Management Interrupt (SMI) operation and accord to the practical requirements of users. Moreover, user can monitor and correct the SMI operation to raise its application value.

The foregoing descriptions of the detailed embodiment are only illustrated to disclose the features and functions of the present invention and not restrictive of the scope of the present invention. The essential techniques are widely defined in the following claims. Any embodiment or method accomplished by others which is identical or equivalent to those defined in the appended claims should be considered to fall within the scope of the claims.

What is claimed is:

1. An interrupt control system applied in an electronic device having an interrupt service system, for controlling the interrupt service system to execute corresponding interrupt handlers, the interrupt control system comprising:
a setting unit having a setting interface for setting a variety of specified interrupt control instructions;
a storage unit having a first data storage area and a second data storage area, with an interrupt control program being stored in the first data storage area; and
a central processing unit (CPU) electrically connected to the setting unit and the storage unit, for storing the specified interrupt control instructions set by the setting unit to the second data storage area and executing the interrupt control program stored in the first data storage unit, so as to control the interrupt service system to execute the corresponding interrupt handlers in accordance with the specified interrupt control instructions.

2. The interrupt control system of claim 1, wherein the interrupt control system is an application program running in an operating system of the electronic device.

3. The interrupt control system of claim 1, wherein the interrupt service system utilizes a system management interrupt Handler (SMI Handler) to execute the interrupt handlers.

4. The interrupt control system of claim 3, wherein the SMI Handler is embedded in a basic input/output system (BIOS) of the electronic device.

5. The interrupt control system of claim 3, wherein the specified interrupt control instructions comprise instructions for a disabling selection, an enabling selection, a periodically disabling selection and a periodically enabling of the SMI Handler.

6. The interrupt control system of claim 3 further comprising an editing unit for editing a User Handler.

7. The interrupt control system of claim 6, wherein the User Handler is stored in the first data storage area.

8. The interrupt control system of claim 6, wherein the specified interrupt control instructions further comprise instructions for replacing the SMI Handler with the User Handler, adding the User Handler to the SMI Handler, and deleting the User Handler from the SMI Handler.

9. The interrupt control system of claim 8, wherein replacing the SMI Handler with the User Handler refers to disabling the SMI Handler and executing the User Handler.

10. The interrupt control system of claim 8, wherein adding the User Handler to the SMI Handler refers to executing the User Handler prior to the SMI Handler.

11. The interrupt control system of claim 1, wherein the first data storage area is a memory.

12. The interrupt control system of claim 1, wherein the interrupt control instructions stored in the second data storage area are automatically cleared after the electronic device is powered-off.

13. The interrupt control system of claim 12, wherein the second data storage area is a random access memory (RAM).

14. The interrupt control system of claim 1, wherein the CPU utilizes the interrupt control program to execute a write operation on an input/output port of the electronic device, so as to trigger an interrupt signal.

15. The interrupt control system of claim 1, wherein the interrupt service system produces a response code for displaying a current performing state of the interrupt service system and transmits the response code to the interrupt control program when the interrupt control program is controlling the interrupt service system to execute the corresponding interrupt handlers.

16. The interrupt control system of claim 1, wherein the CPU starts to execute the interrupt control program as soon as the interrupt service system receives and executes an interrupt signal.

17. The interrupt control system of claim 1, wherein the CPU executes the interrupt control program when the interrupt service system performs an operation in accordance with a rule defined by the interrupt control instructions.

18. The interrupt control system of claim 1, wherein the electronic device is one selected from the group consisting of a personal computer (PC), a notebook, a personal digital assistant (PDA) and a palm computer.

19. An interrupt control method applied in an electronic device having an interrupt service system, for controlling the interrupt service system to perform corresponding interrupt handler, the interrupt control method comprising the steps of:
storing an interrupt control program in a first data storage area;
displaying a setting interface for setting specified interrupt control instructions and storing the specified interrupt control instructions in a second data storage area; and
executing the interrupt control program stored in the first data storage area to control the interrupt service system to execute the corresponding interrupt handlers in accordance with the special interrupt control instructions.

20. The interrupt control method of claim 19, which is implemented by an application program running in an operating system of the electronic device.

21. The interrupt control method of claim 19, wherein the interrupt service system utilizes a SMI Handler to execute the interrupt handlers.

22. The interrupt control method of claim 21, wherein the SMI Handler is embedded in a BIOS of the electronic device.

23. The interrupt control method of claim 21, wherein the specified interrupt control instructions comprise instructions for a disabling selection, an enabling selection, a periodically disabling selection and a periodically enabling selection of the SMI Handler.

24. The interrupt control method of claim 19, further comprising editing a User Handler and storing the User Handler in the second data storage area.

25. The interrupt control method of claim 24, wherein the specified interrupt control instructions comprise instructions for replacing the SMI Handler with the User Handler, adding the User Handler to the SMI Handler, and deleting the User Handler from the SMI Handler.

26. The interrupt control method of claim 25, wherein replacing the SMI Handler with the User Handler refers to disabling the SMI Handler and executing the User Handler.

27. The interrupt control method of claim 25, wherein adding the User Handler to the SMI Handler refers to executing the User Handler prior to the SMI Handler.

28. The interrupt control method of claim 19, wherein the first data storage area is a memory.

29. The interrupt control method of claim 19, wherein the interrupt control instructions stored in the second data storage area are automatically cleared after the electronic device is powered-off.

30. The interrupt control method of claim 29, wherein the second data storage area is a RAM.

31. The interrupt control method of claim 19, wherein the CPU utilizes the interrupt control program to perform a write operation on an input/output port of the electronic device, so as to trigger an interrupt signal.

32. The interrupt control method of claim 19, wherein the interrupt service system produces a response code for displaying a current performing state of the interrupt service system and transmits the response code to the interrupt control program when the interrupt control program is controlling the interrupt service system to execute the corresponding interrupt handlers.

33. The interrupt control method of claim 19, wherein the CPU starts to execute the interrupt control program as soon as the interrupt service system receives and executes an interrupt signal.

34. The interrupt control method of claim 19, wherein the CPU executes the interrupt control program when the interrupt service system performs an operation in accordance with a rule defined by the interrupt control instructions.

35. The interrupt control method of claim 19, wherein the electronic device is one selected from the group consisting of a PC, a notebook, a PDA and a palm computer.
